(19) United States
(12) Patent Application Publication
(10) Pub. No.: US 2025/0027796 A1
(43) Pub. Date: Jan. 23, 2025

(54) WIRE ASSEMBLY

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hironobu RACHI, Mie (JP); Kazuo NAKASHIMA, Mie (JP); Yusaku MAEDA, Mie (JP)

(21) Appl. No.: 18/713,909

(22) PCT Filed: Nov. 28, 2022
(86) PCT No.: PCT/JP2022/043808

§ 371 Date: May 28, 2024

(30) Foreign Application Priority Data
Dec. 13, 2021 (JP) 2021-201546

(51) Int. Cl. G01D 11/24; H01B 3/30; H01B 7/282

(52) U.S. Cl. CPC G01D 11/245; H01B 3/308; H01B 7/282

(57) ABSTRACT

A wire assembly includes a wire including a conductor and a resin coating, an end member connected to the conductor at an end part of the wire, and a resin molded member for covering a region from the end member to the resin coating. A value of an adhesion work obtained from a surface free energy of the resin molded member and a surface free energy of the resin coating is 45 mJ/m² or more.

### TECHNICAL FIELD

The present disclosure relates to a wire assembly.

This application claims a priority of Japanese Patent Application No. 2021-201546 filed with the Japan Patent Office on Dec. 13, 2021, the contents of which are hereby incorporated by reference.

### BACKGROUND

Patent Document 1 discloses a composite cable in which a first wire and a multi-core wire are collectively covered by a sheath. The multi-core wire is configured such that a plurality of second wires are covered by an inner sheath. The second wire is provided with a conductor and an insulation layer. The inner sheath is a resin coating arranged on the outmost periphery of the multi-core wire. An end member and a resin molded member are provided on an end part of the multi-core wire. The end member is a sensor to be electrically connected to the conductors of the second wires or the like. The resin molded member covers a region from the end member to the outer periphery of the inner sheath. A connected part of the conductors and the end member is waterproofed by the resin molded member.

### PRIOR ART DOCUMENT

### Patent Document

Patent Document 1: JP 2017-131054 A

### SUMMARY OF THE INVENTION

The present disclosure is directed to a wire assembly with a wire including a conductor and a resin coating, an end member connected to the conductor at an end part of the wire, and a resin molded member for covering a region from the end member to the resin coating, a value of an adhesion work obtained from a surface free energy of the resin molded member and a surface free energy of the resin coating being 45 mJ/m² or more.

### BRIEF DESCRIPTION OF THE DRAWINGS

FIG. 1 is a schematic diagram of a wire assembly described in an embodiment.

FIG. 2 is a section of a wire described in the embodiment.

FIG. 3 is a schematic diagram of a testing device for Test Example 1.

### DETAILED DESCRIPTION TO EXECUTE THE INVENTION

### Technical Problem

To waterproof the connected part, the resin molded member and the inner sheath, which is a resin coating, need to be tightly adhered. However, depending on the affinity of a resin constituting the resin molded member and a resin constituting the resin coating, sufficient waterproof performance may not be obtained. This affinity possibly changes depending on grades of the resins, molecular weights of the resins, ratios of additives contained in the resins or the like. For example, there is a difference in adhesive ability to the resin coating between a resin molded member made of a resin A and a resin molded member made of the resin A containing an additive.

In view of the above situation, one object of the present disclosure is to provide a wire assembly having good waterproof performance between a resin molded member and a resin coating.

### Effect of Invention

A wire assembly of the present disclosure is excellent in waterproof performance between a resin molded member and a resin coating in the wire assembly.

### Description of Embodiments of Present Disclosure

The present inventors studied to specify a physical quantity related to adhesiveness between a resin molded member and a resin coating and evaluate waterproofness between the resin molded member and the resin coating based on whether or not that physical quantity is equal to or more than a predetermined value. That resulted in acquiring knowledge that sufficient waterproofness was ensured between the resin molded member and the resin coating in the wire assembly having an adhesion work value satisfying a predetermined value. The details of the adhesion work are described in detail later. The wire assembly of the present disclosure was obtained based on the above knowledge.

First, contents of embodiments of the present disclosure are listed and described.

(1) A wire assembly according to an embodiment is provided with a wire including a conductor and a resin coating, an end member connected to the conductor at an end part of the wire, and a resin molded member for covering a region from the end member to the resin coating, a value of an adhesion work obtained from a surface free energy of the resin molded member and a surface free energy of the resin coating being 45 mJ/m² or more.

A surface free energy is a surface tension of a solid. An adhesion work is a work quantity necessary to pull apart the resin molded member and the resin coating adhered at an interface. Methods for calculating the surface free energy and the adhesion work are described in detail later in an embodiment.

If the value of the adhesion work is 45 mJ/m² or more, the resin molded member and the resin coating can be said to be firmly adhered. Therefore, waterproofness between the resin molded member and the resin coating tends to be satisfactorily maintained.

(2) In the wire assembly of (1) described above, a distortion difference between the resin molded member and the resin coating is 0.02 or less, and the distortion difference is a difference between a distortion of the resin molded member and a distortion of the resin coating when a temperature changes from 90° C. to 20° C.

A distortion of a member when the temperature changes from 90° C. to 20° C. is obtained by multiplying the sum of linear expansion coefficients of the member at every 10° C. by a temperature difference. A specific method for obtaining the distortion is described in detail in the embodiment.

If the distortion difference between the resin molded member and the resin coating is small, it can be said that a stress hardly acts on the interface between the resin molded member and the resin coating. If the distortion difference is 0.02 or less, waterproofness between the resin molded member and the resin coating tends to be satisfactorily maintained.

(3) In the wire assembly of (1) or (2) described above, shear adhesion strength of the resin molded member and the resin coating is 0.2 MPa or more.

Shear adhesion strength is obtained by dividing a load for causing adhesion destruction when a tensile test is conducted by a contact area. The contact area is an area of a contact part of the resin molded member and the resin coating. A specific method for obtaining the shear adhesion strength is described in detail in the embodiment.

If the shear adhesion strength is large, the resin molded member and the resin coating can be said to be firmly adhered. If the shear adhesion strength is 0.2 MPa or more, waterproofness between the resin molded member and the resin coating tends to be satisfactorily maintained.

(4) In the wire assembly of any one of (1) to (3) described above, a difference between a linear expansion coefficient of the resin molded member and a linear expansion coefficient of the resin coating at 20° C. is 2.2×10⁻⁴ or less.

The linear expansion coefficient of the resin molded member and the linear expansion coefficient of the resin coating are obtained by thermomechanical analysis (TMA).

If the difference between the linear expansion coefficient of the resin molded member and that of the resin coating is large, peeling may occur at the interface between the resin molded member and the resin coating during the manufacturing of the wire assembly. That is, if the above difference is small, it can be said that a stress hardly acts on the interface between the resin molded member and the resin coating. If the above difference at 20° C. is 2.2×10⁻⁴ or less, waterproofness between the resin molded member and the resin coating tends to be satisfactorily maintained.

(5) In the wire assembly of any one of (1) to (4) described above, an elastic modulus of the resin coating at 20° C. is 100 MPa or less.

The elastic modulus of the resin coating at 20° C. affects the magnitude of a stress generated in the resin coating when the wire assembly is manufactured as described later in the embodiment. If the elastic modulus of the resin coating at 20° C. is 100 MPa or less, waterproofness between the resin molded member and the resin coating tends to be satisfactorily maintained.

(6) In the wire assembly of any one of (1) to (5) described above, the resin molded member covers the entire end member.

In the wire assembly in which the resin molded member covers the entire end member, only the interface between the resin molded member and the resin coating is a moisture intrusion route into a connected part of the conductor of the wire and the end member. Since waterproofness between the resin molded member and the resin coating is high in the wire assembly of the embodiment, moisture hardly adheres to the connected part. Therefore, the corrosion of the conductor, the damage of the end member or the like is suppressed.

(7) In the wire assembly of any one of (1) to (6) described above, the end member is a sensor.

If the end member is a sensor, a physical quantity in a device installed with the wire assembly can be measured. For example, if the wire assembly is installed in a vehicle, the sensor can monitor a physical quantity related to a vehicle operation. The type of the sensor is not particularly limited.

### Details of Embodiment of Present Disclosure

Hereinafter, an embodiment of the present disclosure is described in detail with reference to the drawings as appropriate. The same reference signs in figures denote the same components. The present invention is not limited to the illustrated embodiment, but is represented by claims and intended to include all changes in the scope of claims and in the meaning and scope of equivalents.

### EMBODIMENT

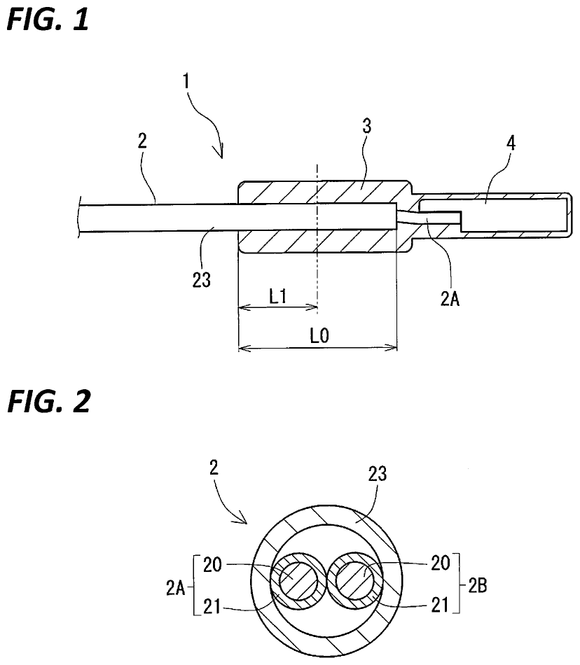

A wire assembly 1 of this example shown in FIG. 1 is provided with a wire 2, a resin molded member 3 and an end member 4. One feature of the wire assembly 1 of this example is that a resin coating 23 arranged on the outermost periphery of the wire 2 and the resin molded member 3 are firmly adhered. Each component of the wire assembly 1 is described below. Thereafter, physical quantities for specifying that the resin coating 23 and the resin molded member 3 are firmly adhered are described.

### <<Wire>>

As shown in a section of FIG. 2, the wire 2 of this example is a multi-core wire, i.e. so-called a twisted pair cable. The wire 2 of this example is provided with two core wires 2A, 2B. The core wires 2A, 2B of this example have the same configuration. The number of the core wires is not particularly limited. A plurality of core wires may respectively have different configurations. Unlike this example, the wire 2 may be a single-core wire.

The core wire 2A, 2B includes a conductor 20 and an insulation layer 21. The conductor 20 is made of an electrically conductive material such as aluminum, aluminum alloy, copper or copper alloy. The conductor 20 is electrically connected to the end member 4 (FIG. 1). The insulation layer 21 is, for example, made of insulating resin such as polyvinyl chloride or polyethylene.

The two core wires 2A, 2B are arranged inside the tube-like resin coating 23. The resin coating 23 of this example is a so-called sheath. In this example, there is a gap between the core wires 2A, 2B and the resin coating 23. Unlike this example, a substance such as a resin may be filled between the core wires 2A, 2B and the resin coating 23. The filled substance is, for example, a urethane resin. A shielding layer and the like may be provided on an inner peripheral side of the resin coating 23.

As shown in FIG. 1, a part of the resin molded member 3 is arranged on the outer periphery of the resin coating 23. The inner peripheral surface of the resin molded member 3 is adhered to the outer peripheral surface of the resin coating 23. A main component of the resin coating 23 is a resin material. The main component means a component having a content of 50 mass % or more in the resin coating 23. The resin material is, for example, a polyurethane (PU) resin, a polyester (PE) resin or the like. The resin coating 23 may contain an additive such as a flame retardant or filler or the like.

Here, even if the same resin material for constituting the resin coating 23 is used, adhesiveness between the resin coating 23 and the resin molded member 3 changes depending on the number of branched chains of the resin material, a molecular weight, the type of an additive contained in the resin coating 23 and a content of the additive. Therefore, even if the resin coating 23 is, for example, made of PU resin, it may not be possible to satisfy an adhesion work value to be described later.

### <<End Member>>

The end member 4 shown in FIG. 1 is electrically connected to the conductors 20 (FIG. 2) of the wire 2. The end member 4 of this example is a vehicle wheel speed sensor. The sensor is not limited to the vehicle wheel speed sensor. For example, the sensor may be a temperature sensor, an acceleration sensor or the like. Unlike this example, the end member 4 may be a terminal or the like.

### <<Resin Molded Member>>

The resin molded member 3 covers a region from the end member 4 to the resin coating 23. In this example, the resin molded member 3 covers the entire end member 4.

The resin molded member 3 is overlaid on the outer periphery of the resin coating 23 of the wire 2. That is, the inner peripheral surface of the resin molded member 3 is adhered to the outer peripheral surface of the resin coating 23. The adhesion of moisture to a connected part of the conductors 20 (FIG. 2) of the wire 2 and the end member 4 is suppressed by the resin molded member 3. As an overlap length L0 of the resin molded member 3 and the resin coating 23 along a length direction of the wire 2 increases, waterproofness by the resin molded member 3 is improved. The length direction is a direction from a first end part to a second end part of the wire 2 along a length of the wire 2. If the length L0 is too long, the resin molded member 3 is enlarged and it becomes difficult to arrange the wire assembly 1 in a device. From the perspective of improving waterproofness and suppressing enlargement, the length L0 is preferably, for example, 1 mm or more and 100 mm or less. Further, the length L0 may be 5 mm or more and 50 mm or less.

If the wire 2 is a single-core wire unlike this example, the resin molded member 3 covers the outer periphery of the insulation layer 21 arranged on the outer periphery of the conductor 20. That is, the insulation layer 21 is equivalent to the resin coating of the wire 2 in the wire assembly provided with the single-core wire.

The outer shape of the resin molded member 3 is not particularly limited. The outer shape of the resin molded member 3 of this example is a shape along the outer shape of the end member 4. Unlike this example, the resin molded member 3 may be provided with a flange or the like for fixing the wire assembly 1 to an installation target.

A main component of the resin molded member 3 is a resin material. The main component means a component having a content of 50 mass % or more in the resin molded member 3. The resin material is, for example, a polyamide (PA) resin, a polyphenylene sulfide (PPS) resin, a polybutylene terephthalate (PBT) resin or the like. The resin molded member 3 may contain an additive such as a flame retardant or filler or the like.

Here, even if the same resin material for constituting the resin molded member 3 is used, adhesiveness between the resin coating 23 and the resin molded member 3 changes depending on the number of branched chains of the resin material, a molecular weight, the type of an additive contained in the resin molded member 3 and a content of the additive. Therefore, even if the resin molded member 3 is, for example, made of PA resin, it may not be possible to satisfy the adhesion work value to be described later.

In the wire assembly 1 of this example, the “adhesion work” is specified as an index for evaluating waterproofness between the resin molded member 3 and the resin coating 23. If the adhesion work in the wire assembly 1 is equal to or more than a predetermined value, waterproofness between the resin molded member 3 and the resin coating 23 can be said to be high. Besides, indices for evaluating waterproofness are, for example, a “distortion difference”, “shear adhesion strength”, a “linear expansion coefficient difference” and an “elastic modulus of the resin coating 23”. Each index is described in detail below.

### <<Adhesion Work>>

The adhesion work is an index indicating the magnitude of adhesiveness between the resin molded member 3 and the resin coating 23. That is, the adhesion work is an index indicating peeling difficulty of the resin coating 23 from the resin molded member 3 and also an index for evaluating waterproofness between the resin molded member 3 and the resin coating 23.

The adhesion work is obtained from a surface free energy of the resin molded member 3 and that of the resin coating 23. A surface free energy is equivalent to a surface tension on a solid. To obtain the adhesion work, the surface free energy of the resin molded member 3 and that of the resin coating 23 are first obtained. The surface free energy is obtained by using a Young equation and an expansion Fowkes formula described below.

### Young Equation

$${γ}_{s} = {γ}_{L} cos θ + {γ}_{S L}$$

where:
θ contact angle of liquid droplets stationary on a surface of a solid; unit is (π/180)rad,
γ_{S} . . . surface tension of the solid, i.e. surface free energy; unit is mJ/m²,
γ_{L} . . . surface tension of a liquid constituting the liquid droplets; unit is mJ/m², and
γ_{SL} . . . surface tension between the solid and the liquid; unit is mJ/m².

### Expansion Fowkes Formula

$${γ}_{S L} = {γ}_{S} + {γ}_{L} - 2 {( {γ}_{S}^{d} {γ}_{L}^{d} )}^{1 / 2} - 2 {( {γ}_{S}^{P} {γ}_{L}^{P} )}^{1 / 2} - 2 {( {γ}_{S}^{H} {γ}_{L}^{H} )}^{1 / 2}$$

where:
γL^{d} . . . dispersion component in the surface tension of the liquid,
γ_{L}^{P} . . . polar component in the surface tension of the liquid,
γ_{L}^{H} . . . hydrogen bonding component in the surface tension of the liquid,
γ_{S}^{d} . . . dispersion component in the surface free energy of the solid,
γ_{S}^{P} . . . polar component in the surface free energy of the solid, and
γ_{S}^{H} . . . hydrogen bonding component in the surface free energy of the solid.

The unit of each component of the surface tension is mJ/m², and the unit of each component of the surface free energy is mJ/m². Note that an induction component is also present in the surface tension, but the induction component may be ignored since being very small.

If the Young equation is substituted into the expansion Fowkes formula, the following equation (1) is obtained.

$${γ}_{L} ( 1 + cos θ ) = 2 {( {γ}_{S}^{d} {γ}_{L}^{d} )}^{1 / 2} + 2 {( {γ}_{S}^{P} {γ}_{L}^{P} )}^{1 / 2} + 2 {( {γ}_{S}^{H} {γ}_{L}^{H} )}^{1 / 2} \qquad Equation ( 1 )$$

The surface free energy of the solid is obtained by causing three types of liquids whose γ_{L}, γ_{L}^{d}, γ_{L}^{P} and γ_{L}^{H} are known to adhere to the solid and measuring the contact angle θ. For example, to obtain γ_{S}^{d}, γ_{S}^{P} and γ_{S}^{H} related to the surface free energy of the resin molded member 3, a first liquid, a second liquid and a third liquid having known numerical values of the surface tension are respectively caused to adhere to the resin molded member 3 and three linear equations with three unknowns are obtained. By solving the three linear equations with three unknowns, γ_{S}^{d}, γ_{S}^{P} and γ_{S}^{H} are obtained. A liquid having the respective known components of the surface tension is, for example, pure water. The surface free energy of the resin coating 23 is also obtained in the same way as that of the resin molded member 3.

The adhesion work is obtained by the following Dupre equation.

### Dupre Equation

$${γ}_{12} + W = {γ}_{1} + {γ}_{2}$$

where:
W . . . adhesion work; a unit is mJ/m²,
γ₁₂ . . . interface free energy; a unit is mJ/m²,
γ₁ . . . surface free energy of the resin molded member 3, and
γ₂ . . . surface free energy of the resin coating 23.

Here, γ₁₂ is obtained by the following expansion Fowkes formula.

### Expansion Fowkes Formula

$${γ}_{12} = {γ}_{1} + {γ}_{2} - 2 {( {γ}_{1}^{d} {γ}_{2}^{d} )}^{1 / 2} - 2 {( {γ}_{1}^{P} {γ}_{2}^{P} )}^{1 / 2} - 2 {( {γ}_{1}^{H} {γ}_{2}^{H} )}^{1 / 2}$$

where:
γ₁^{d} . . . dispersion component in the surface free energy of the resin molded member 3,
γ₁^{P} . . . polar component in the surface free energy of the resin molded member 3,
γ₁^{H} . . . hydrogen bonding component in the surface free energy of the resin molded member 3,
γ₂^{d} . . . dispersion component in the surface free energy of the resin coating 23,
γ₂^{P} . . . polar component in the surface free energy of the resin coating 23, and
γ₂^{H} . . . hydrogen bonding component in the surface free energy of the resin coating 23.

If the expansion Fowkes formula is substituted into the Dupre equation, the following equation (2) is obtained.

$$W = 2 {( {γ}_{1}^{d} {γ}_{2}^{d} )}^{1 / 2} + 2 {( {γ}_{1}^{P} {γ}_{2}^{P} )}^{1 / 2} + 2 {( {γ}_{1}^{H} {γ}_{2}^{H} )}^{1 / 2} \qquad Equation ( 2 )$$

Each component of the surface free energy of the resin molded member 3 to be substituted into Equation (2) is obtained by Equation (1). Similarly, each component of the surface free energy of the resin coating 23 to be substituted into Equation (2) is also obtained by Equation (1).

If the adhesion work W is large, the resin molded member 3 and the resin coating 23 can be said to be firmly adhered. The adhesion work W in the wire assembly 1 of this example is 45 mJ/m² or more. If the value of the adhesion work W is 45 mJ/m² or more, waterproofness between the resin molded member 3 and the resin coating 23 tends to be satisfactorily maintained. The adhesion work W is preferably 65 mJ/m² or more, more preferably 80 mJ/m² or more.

### <<Distortion Difference>>

The resin molded member 3 is formed on the outer peripheries of the wire 2 and the end member 4 in the following procedure. Out of the wire 2 connected to the end member 4, an end part of the wire 2 including the end member 4 is arranged in a mold. Then, the material of the resin molded member 3 in a molten state is injected into the mold. A temperature of the mold is about 70° C. When the molten resin flows into the mold, the resin coating 23 arranged in the mold is heated to about 90° C. If the wire assembly 1 is removed from the mold, the wire assembly 1 is cooled to a room temperature. If the room temperature is 20° C., the temperature of the resin molded member 3 and that of the resin coating 23 change from 90° C. to 20° C. during the manufacturing of the wire assembly 1. The resin molded member 3 is distorted due to a temperature change. Similarly, the resin coating 23 is also distorted. If there is a difference between the distortion of the resin molded member 3 and that of the resin coating 23, a stress acts on an interface between the resin molded member 3 and the resin coating 23. This stress is a force for pulling the resin molded member 3 away from the resin coating 23. Therefore, the difference between the distortion of the resin molded member 3 and that of the resin coating 23 can be said to be an index for evaluating waterproofness between the resin molded member 3 and the resin coating 23.

The distortion of each member can be obtained based on a linear expansion coefficient. A linear expansion coefficient of the resin molded member 3 and that of the resin coating 23 are measured by a method in accordance with JIS K 7197:2012. Specifically, these linear expansion coefficients are measured by TMA. In TMA, the linear expansion coefficient (1/° C.) is obtained at every 10° C. Specifically, a linear expansion coefficient X1 of from 20° C. to 30° C., a linear expansion coefficient X2 of from 30° C. to 40° C., a linear expansion coefficient X3 of from 40° C. to 50° C., a linear expansion coefficient X4 of from 50° C. to 60° C., a linear expansion coefficient X5 of from 60° C. to 70° C., a linear expansion coefficient X6 of from 70° C. to 80° C., and a linear expansion coefficient X7 of from 80° C. to 90° C. are obtained. As shown in Equation (3) below, the distortion of each member can be obtained by multiplying the sum of the linear expansion coefficients from 90° C. to 20° C. by a temperature difference.

$$Distortion = ( X 1 + X 2 + X 3 + X 4 + X 5 + X 6 + X 7 ) \times 70 \qquad Equation ( 3 )$$

The distortion difference is an absolute value of the difference between the distortion of the resin molded member 3 obtained by Equation (3) and the distortion of the resin coating 23 obtained by Equation (3). If the distortion difference is small, it can be said that a strong stress hardly acts on the interface between the resin coating 3 and the resin coating 23. Therefore, the distortion difference is preferably 0.02 or less, more preferably 0.0129 or less, even more preferably 0.0011 or less.

### <<Shear Adhesion Strength>>

Shear adhesion strength was obtained by dividing a load for causing adhesion destruction by a contact area when a tensile test of pulling the wire 2 and the resin molded member 3 in directions separating from each other was conducted. Therefore, the shear adhesion strength can be said to be an index for evaluating waterproofness between the resin molded member 3 and the resin coating 23.

The shear adhesion strength of this example can be obtained as follows. For example, the wire assembly 1 is cut at a position indicated by a two-dot chain line of FIG. 1. The outer periphery of the wire 2 and the resin molded member 3 are respectively chucked, and the wire 2 is pulled in a direction separating from the resin molded member 3 along the length direction of the wire 2. A pulling speed is 10 mm/min. A load when either the resin molded member 3 or the resin coating 23 is destroyed is measured. That load is divided by a contact area between the resin molded member 3 and the resin coating 23. A unit of the load is N, and a unit of the contact area is mm². The contact area is obtained by multiplying a circumferential length of the wire 2, i.e. a circumferential length of the resin coating 23, by a length L1. The circumferential length is obtained by multiplying a diameter of the wire 2 by 7r. The length L1 is a distance from the cut surface of the wire assembly 1 to an end part of the resin molded member 3 on the side of the wire 2.

If the shear adhesion strength of the resin molded member 3 and the resin coating 23 is large, the resin molded member 3 and the resin coating 23 can be said to be firmly adhered. Therefore, the shear adhesion strength is preferably 0.2 MPa or more, more preferably 0.8 MPa or more, even more preferably 1.5 MPa or more.

### <<Linear Expansion Coefficient Difference>>

The linear expansion coefficient is related to an amount of expansion and contraction associated with a temperature change. Accordingly, if there is a difference between the linear expansion coefficient of the resin molded member 3 and that of the resin coating 23, a stress acts on the interface between the resin molded member 3 and the resin coating 23. Thus, the difference between the linear expansion coefficient of the resin molded member 3 and that of the resin coating 23 can be said to be an index for evaluating waterproofness between the resin molded member 3 and the resin coating 23. The linear expansion coefficient of the resin molded member 3 and that of the resin coating 23 are respectively obtained by TMA.

If the difference between the linear expansion coefficient of the resin molded member 3 and that of the resin coating 23 is large, peeling may occur at the interface between the resin molded member 3 and the resin coating 23 during the manufacturing of the wire assembly 1. If the linear expansion coefficient difference at 20° C. is 2.2×10⁻⁴/° C. or less, waterproofness between the resin molded member 3 and the resin coating 23 tends to be satisfactorily maintained. The linear expansion coefficient difference is more preferably 2.0×10⁻⁴/° C. or less, even more preferably 1.5×10⁻⁴/° C. or less.

### <<Elastic Modulus>>

As described above, the resin coating 23 of the wire 2 is heated in the mold during the manufacturing of the wire assembly 1. If an elastic modulus of the resin coating 23 is large, the resin coating 23 is significantly distorted in the process of removing the wire assembly 1 from the mold and cooling the resin coating 23 to the room temperature. A stress generated in the resin coating 23 due to this distortion may peel the resin molded member 3 from the resin coating 23. The stress is obtained by multiplying the distortion generated in the resin coating 23 by the elastic modulus of the resin coating 23. Accordingly, by selecting the resin coating 23 having a low elastic modulus, the resin molded member 3 becomes less likely to be peeled from the resin coating 23. Since the elastic modulus of the resin coating 23 is maximized at 20° C. in a temperature range of the resin coating 23 in the manufacturing process of the wire assembly 1, the elastic modulus of the resin coating 23 at 20° C. needs to be measured to evaluate waterproof performance. The elastic modulus is obtained by a measurement method in accordance with JIS K 7244.

If the elastic modulus of the resin coating 23 is 100 MPa or less, waterproofness between the resin molded member 3 and the resin coating 23 tends to be satisfactorily maintained. The elastic modulus is preferably 60 MPa or less, more preferably 20 MPa or less.

### Test Example 1

In this Test Example, the wire assemblies 1 of samples No. 1 to No. 6, in which the material of the resin molded member 3 and that of the resin coating 23 were different, were fabricated. The resin molded member 3 is either a resin molded member A or a resin molded member B shown in Table 1. The resin molded member A is made of PA6T, which is a heat resistant PA resin. A melting point of the resin molded member A is 300° C. The resin molded member B is made of PA612, which is one type of a PA resin. A melting point of the resin molded member B is 220° C.

TABLE 1

| | Material | Melting Point (° C.) |
|---|---|---|
| Resin Molded Member | PA6T | 300 |
| A | | |
| Resin Molded Member | PA612 | 220 |
| B | | |

The resin coating 23 is any one of a resin coating C, a resin coating D, a resin coating E, a resin coating F, a resin coating G and a resin coating H shown in Table 2. In Table 2, “YES” in a cross-linkage item of Table 2 means that the resin is cross-linked in the resin coating. “YES” in a filler item means that a filler is contained in the resin coating. “YES” in a flame retardant item means that a flame retardant is contained in the resin coating. The flame retardant was a metal hydroxide. A content of the filler in the resin coating C was 50 mass % when the resin coating C was 100 mass %. A content of the filler in the resin coating F was 40 mass % when the resin coating F was 100 mass %.

TABLE 2

| | | Cross- | | Flame |
|---|---|---|---|---|
| | Material | Linkage | Filler | Retardant |
| Resin | PE Resin | NO | YES | NO |
| Coating C | | | | |
| Resin | PU Resin | YES | NO | NO |
| Coating D | | | | |
| Resin | PU Resin | NO | NO | NO |
| Coating E | | | | |
| Resin | PE Resin | NO | YES | NO |
| Coating F | | | | |
| Resin | PE Resin | YES | NO | NO |
| Coating G | | | | |
| Resin | PE Resin | YES | NO | YES |
| Coating H | | | | |

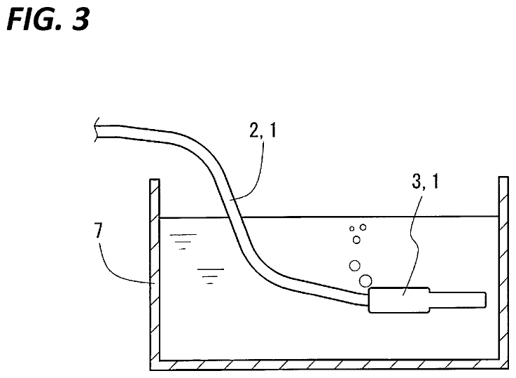

The wire assemblies 1 of Samples No. 1 to No. 6 were subjected to a leak test. A summary of the leak test is shown in FIG. 3. As shown in FIG. 3, water was pooled in a water tank 7 and the resin molded member 3 of the wire assembly 1 was placed in water. Subsequently, air was fed into the inside of the wire 2 from an end part opposite to the resin molded member 3 by an unillustrated air pump. An air pressure was gradually increased and a value of a pressure meter of the air pump was recorded when air leaked from a gap between the resin molded member 3 and the resin coating 23. The value of the pressure meter at the time of air leakage is called a leak pressure (kPa). If the leak pressure is 30 kPa or more, waterproofness can be judged to be satisfactory. If the leak pressure is 50 kPa or more, waterproofness can be judged to excellent. Leak pressure results are shown in Table 3. Table 3 also shows the material, the adhesion work (mJ/m²), the distortion difference, the shear adhesion strength (MPa), the linear expansion coefficient difference and the elastic modulus (MPa) of the resin coating of each sample. Each physical quantity was measured in accordance with the method described in the embodiment.

TABLE 3

| | Sample No. | | | | | |
|---|---|---|---|---|---|---|
| | 1 | 2 | 3 | 4 | 5 | 6 |
| Resin Molded Member A | | | | ◯ | ◯ | ◯ |
| Resin Molded Member B | ◯ | ◯ | ◯ | | | |
| Resin Coating C | | ◯ | | | | |
| Resin Coating D | ◯ | | | | | |
| Resin Coating E | | | ◯ | | | |
| Resin Coating F | | | | ◯ | | |
| Resin Coating G | | | | | ◯ | |
| Resin Coating H | | | | | | ◯ |
| Adhesion Work (mJ/m²) | 84 | 67 | 45 | 45 | 40 | 38 |
| Distortion Difference | 0.0011 | 0.0129 | 0.018 | 0.02 | 0.021 | 0.0215 |
| Shear Adhesion Strength (MPa) | 1.5 | 0.8 | 0.2 | 0.2 | 0.1 | 0.1 |
| Linear Expansion Coefficient | 1.1 × 10⁻⁴ | 1.5 × 10⁻⁴ | 2.0 × 10⁻⁴ | 2.2 × 10⁻⁴ | 2.2 × 10⁻⁴ | 2.5 × 10⁻⁴ |
| Difference (1/° C.) | | | | | | |
| Elastic Modulus of Resin Coating | 100 | 55 | 20 | 20 | 120 | 120 |
| (MPa) | | | | | | |
| Leak Pressure (kPa) | 170 | 100 | 55 | 45 | 10 | 5 |

As shown in Table 3, the leak pressures of the wire assemblies 1 of Samples No. 1 to No. 4, in which the adhesion work was 45 mJ/m² or more, significantly exceeded 30 kPa. The waterproofness of the wire assemblies 1 of Samples No. 1 to No. 4 can be judged to be satisfactory. By comparing Samples No. 1 to No. 4, it was found that the higher the adhesion work, the higher the leak pressure. Particularly, the leak pressures of Samples No. 1 and No. 2, in which the adhesion work was 65 mJ/m² or more, significantly exceeded 50 kPa.

From the results shown in Table 3, it was found that the leak pressure of the wire assembly 1 was 30 kPa or more if the distortion difference was 0.02 or less, the shear adhesion strength was 0.2 MPa or more, the linear expansion coefficient difference was 2.2×10⁻⁴ or less and the elastic modulus of the resin coating was 100 MPa or less.

### LIST OF REFERENCE NUMERALS

1 wire assembly
2 wire
2A core wire
2B core wire
20 conductor
21 insulation layer
23 resin coating
3 resin molded member
4 end member
7 water tank
L0 length
L1 length

1. A wire assembly, comprising:
a wire including a conductor and a resin coating;
an end member connected to the conductor at an end part of the wire; and
a resin molded member for covering a region from the end member to the resin coating,
a value of an adhesion work obtained from a surface free energy of the resin molded member and a surface free energy of the resin coating being 45 mJ/m² or more.

2. The wire assembly of claim 1, wherein:
a distortion difference between the resin molded member and the resin coating is 0.02 or less, and
the distortion difference is a difference between a distortion of the resin molded member and a distortion of the resin coating when a temperature changes from 90° C. to 20° C.

3. The wire assembly of claim 1, wherein shear adhesion strength of the resin molded member and the resin coating is 0.2 MPa or more.

4. The wire assembly of claim 1, wherein a difference between a linear expansion coefficient of the resin molded member and a linear expansion coefficient of the resin coating at 20° C. is 2.2×10⁻⁴ or less.

5. The wire assembly of claim 1, wherein an elastic modulus of the resin coating at 20° C. is 100 MPa or less.

6. The wire assembly of claim 1, wherein the resin molded member covers the entire end member.

7. The wire assembly of claim 1, wherein the end member is a sensor.
